(19) United States
(12) Patent Application Publication
(10) Pub. No.: US 2008/0028880 A1
(43) Pub. Date: Feb. 7, 2008

(54) Gravity driven underactuated robot arm for assembly operations inside an aircraft wing box

(76) Inventors: H. Harry Asada, Lincoln, MA (US); Binayak Roy, Cambridge, MA (US)

Correspondence Address: H. Harry Asada, 77 Massachusetts Avenue, 3-346, Cambridge, MA, 02139, US

(21) Appl. No.: 11/497,853

(22) Filed: Aug. 1, 2006

(51) Int. Cl. G05G 1/00

(52) U.S. Cl. 74/469

(57) ABSTRACT

The invention proposes a design and deployment scheme for a hyper-articulated manipulator for assembly operations inside an aircraft wing box. The manipulator comprises nested C-channel structures connected by 1 degree of freedom rotary joints. The wing box has a large span, but is only accessible through multiple small portholes along its length. The manipulator is compact enough to enter the wing-box through the portholes, yet capable of subsequent reconfiguration so as to access multiple assembly points inside the wing-box. Traditional electromechanical actuators powering the rotary joints are unsuitable for this purpose, because of limited space and large payload requirements. The manipulator is an underactuated system which uses a single actuator at the base for the deployment of the C-channel serial linkage structure. The deployment scheme modulates gravitational torques in the system dynamics to rapidly deploy the system to a desired final configuration starting from any initial configuration.

### CROSS REFERENCE TO RELATED APPLICATIONS

Not Applicable.

### FEDERALLY SPONSORED RESEARCH

Not Applicable.

### BACKGROUND OF INVENTION

1. Field of Invention

The present invention relates to an underactuated manipulator for assembly operations in constrained spaces, more specifically to a gravity assisted underactuated manipulator for assembly operations inside an aircraft wing box.

2. Prior Art

Most assembly operations in aircraft manufacturing are currently done manually. The conditions are often ergonomically challenging and these result in low productivity as well as frequent injuries. Thus, there is a need to shift from manual assembly to automated robotic assembly. The following wing-box assembly illustrates this.

Several assembly operations, like burr-less drilling and fastener installations, have to be carried out inside the wing-box. The interior of the wing-box is accessible through small portholes along its length. The portholes are roughly rectangular with dimensions of 45 cm by 23 cm. The wing-box also has a substantial span, which varies from 1 m to 3 m depending upon the size of the aircraft. The height of the wing-box varies from about 20 cm to 90 cm, once again depending upon the size of the aircraft. Presently, the assembly operations are carried out manually. A worker enters the wing-box through the small portholes and lies flat on the base, while carrying out the assembly operations. Evidently the working conditions are ergonomically challenging.

A robot arm capable of performing such assembly operations should be compact enough to enter the wing-box through the small portholes. It should also be capable of subsequent reconfiguration, in order to perform the actual assembly operations at various locations inside the wing-box. There is also a heavy payload attached to the tip of the arm. It is indeed challenging to meet these diverse requirements in the design of a robot arm.

There are robots which meet some of the above requirements. For example, several hyper-redundant mechanisms in the form of snake robots have been developed. They typically comprise serial links connected by 2 degree of freedom joints, which are powered by traditional electric motors. These robots are highly dexterous and can operate in extremely compact spaces. Such robots are typically intended for reconnaissance operations and the issue of payload has not been addressed. A heavy payload requirement would inevitably make the actuation mechanisms bulky and infeasible for our purpose.

Prior art U.S. Pat. No. 4,928,047 controls a multiple degree of freedom manipulator using dynamic coupling. The joint axes are parallel and thus the gravitational torque cannot be modulated for controlling the manipulator. This system requires large motions of the actuated joints and is thus not suited for use in confined spaces. Further, there is an assumption that the cross coupling term M₁₂⁻¹ is non-singular and this assumption is not true for the range of motion in our case.

Prior art U.S. Pat. No. 6,393,340 B2 controls a multiple degree of freedom manipulator with environmental constraints for robotic laparoscopic surgery. The control algorithms described use incremental motions of the active joints and are too slow for the manufacturing operations that are of interest to us. Furthermore, they cannot explicitly exploit large gravitational torques because the device has to follow a complex path inside the human body.

Prior art U.S. Pat. No. 5,377,310 uses complex high speed dynamics of the manipulator for control. These high speed dynamic effects are not present in our system. Instead, we show that the dominant effect is that of gravity and we fully exploit this effect in the design of our control algorithm.

### SUMMARY OF INVENTION

The present invention relates to the design and control of a compact serial link manipulator with an actuated joint and multiple unactuated joints, which may be used for assembly operations inside an aircraft wing box.

We present the design of a manipulator arm which is compact enough to enter an aircraft wing box through small access portholes. The arm is capable of subsequent reconfiguration so as to access multiple assembly points inside the wing box.

The unactuated links are deployed by tilting the actuated base link, which modulates the effect of gravity on the unactuated links. The motion of the actuated link must be restricted to small amplitudes because the arm operates within the confines of the wing box. We present algorithms for point to point control of the unactuated links, while restricting the motion of the actuated base link to small amplitudes.

### DRAWINGS—FIGURES

FIG. 1 is a perspective view of the manipulator arm with all links contracted.

FIG. 2 shows an end view of the links with a payload attached to the last link.

FIG. 3 illustrates the deployment scheme for the arm.

FIG. 4 is a schematic of a 2-link arm for dynamic modeling.

FIG. 5 is a perspective view of the preferred embodiment of a 3-link arm.

FIG. 6 shows the variation of the configuration dependent modulating coefficients.

FIG. 7 shows a typical polynomial sigmoid trajectory with all the parameters.

FIG. 8 shows the overall control scheme under disturbances.

FIG. 9 shows simulation results for the control algorithm.

FIG. 10 is an image of a 3 link robot arm with one actuated and two unactuated joints.

### DETAILED DESCRIPTION

Overview

The current invention pertains to the design and control of a robot arm capable of automated assembly operations inside an aircraft wing. Most assembly operations in aircraft manufacturing are currently done manually. A worker enters the wing through small access portholes and lies flat on the base, while carrying out the assembly operations. Evidently the working conditions are ergonomically challenging. The size and weight of manipulator arms have been the primary impediments in the automation process.

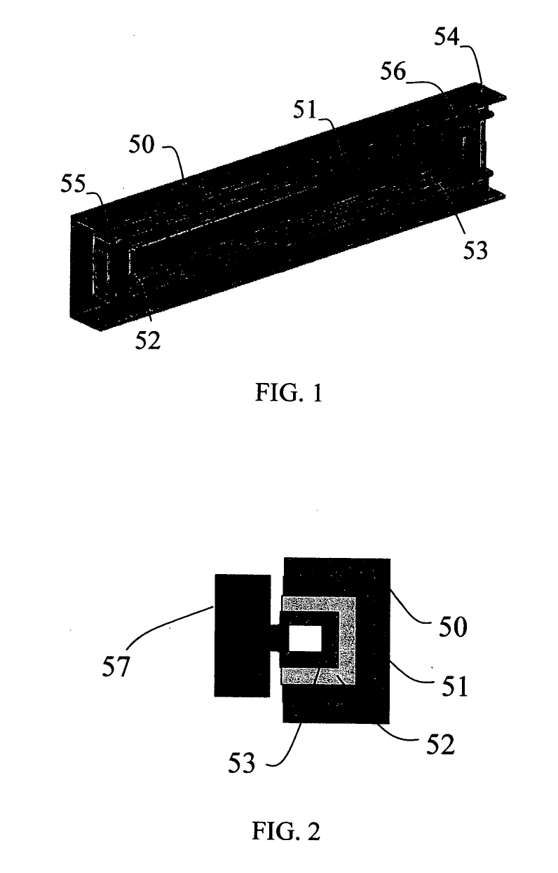

We propose a deployable serial linkage structure for the manipulator arm as shown in FIG. 1. The links are aluminum C channels (50-53) with successively smaller base and leg lengths. The links are connected by 1 degree of freedom rotary joints (54-56). The use of a channel structure is advantageous for a number of reasons. The channels can fold into each other resulting in an extremely compact structure during entry through the access porthole. Once inside the wing, the links may be deployed to access a number of assembly points. The open channel structure also facilitates the attachment of a payload 57 to the last link, as shown in FIG. 2.

The deployment scheme modulates gravitational torques on the links to be deployed by using just one actuator at the base link. The deployed link is locked once it reaches the desired position. The use of a single actuator at the base drastically reduces the weight and size of the robot arm. We also propose an algorithm for point to point control of the links to be deployed.

Gravity Modulation

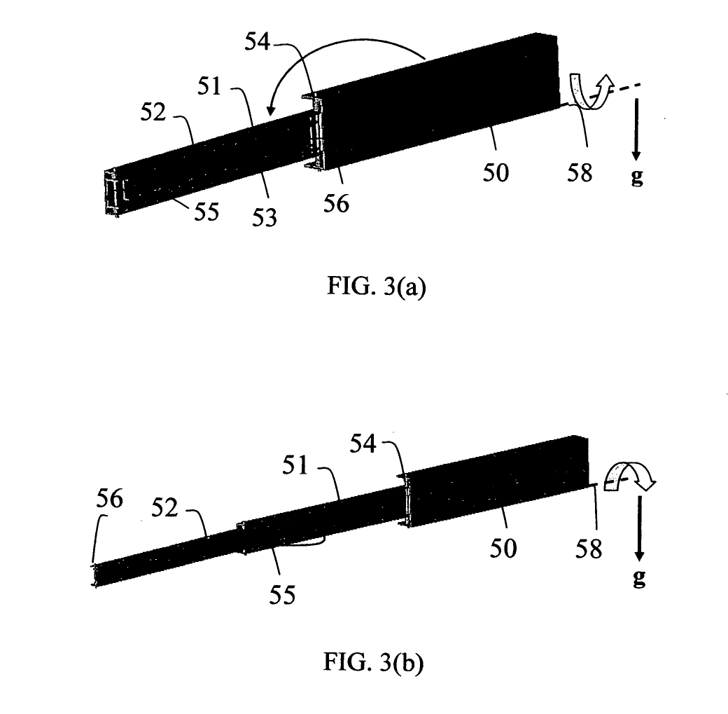

FIG. 3 illustrates the basic deployment process for the linkage structure shown in FIG. 1. There is no dedicated actuator at the individual joints (54-56) along the arm linkage. The only actuated link is 50 which can be rotated about axis 58. The axis of rotation 58 is orthogonal to the direction of gravity. Each joint is free to rotate unless a locking mechanism (not shown) fixes the joint.

As shown in FIG. 3(a), the first step is to free rotary joint 54 and lock rotary joints 55 and 56. Then link 50 is rotated in the counter-clockwise direction. This tends to rotate the free link 51 due to gravity. After arriving at a desired angle, 180 degrees in FIG. 3(a), rotary joint 54 is locked and joint 55 is unlocked. At this time the actuated link 50 is rotated in the clockwise direction, as shown in FIG. 3(b). This allows link 52 to rotate so that it is deployed as seen in FIG. 3(b).

This procedure can be repeated as many times as the number of arm joints. The only actuator needed for this deployment operation is the actuator for link 50 in conjunction with locking mechanisms at individual joints. Contraction of the arm can be performed by reversing the above deployment procedure. Starting with the tip joint, individual joints can be closed one by one towards the first joint.

Dynamic Modeling

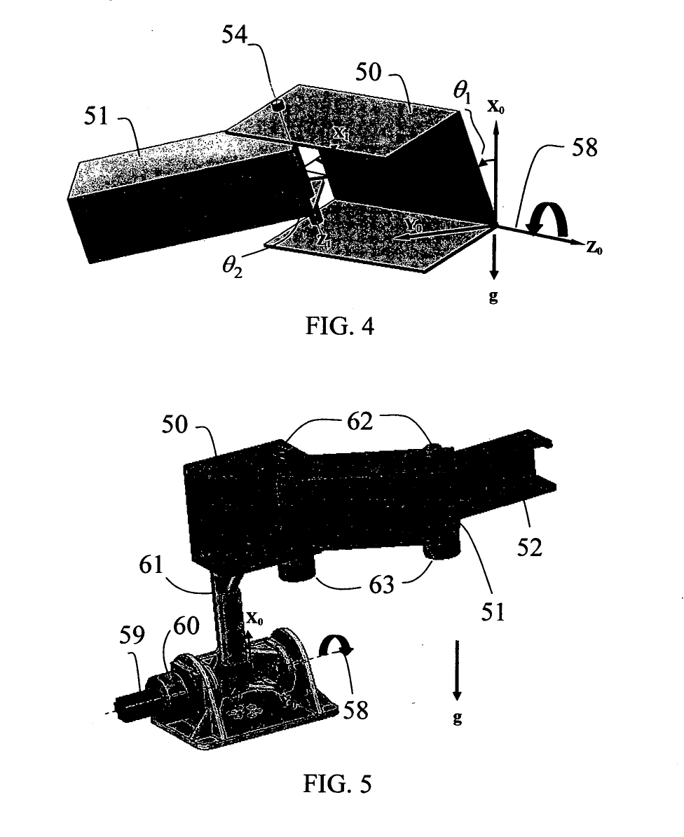

FIG. 4 shows a schematic of a 2-link robot arm with the base link 50 actuated and the 2^{nd} link 51 unactuated. The base link 50 may be rotated about axis 58 by an actuator (not shown).

The angles θ₁ and θ₂ are measured as shown in FIG. 4. We seek rotation of free link 51 about axis 54 (Z₁) by rotating the actuated link 50 about axis 58 (Z₀). It is intuitively obvious that by rotating actuated link 50 about axis 58, we can achieve a rotation of free link 51 about axis 54 because of the gravitational torque. The axis of rotation 54 of free link 51 is also rotating about axis 58. This results in an additional dynamic coupling, as seen in the analysis that follows.

This idea can be extended to multiple serial links. The gravitational and gyroscopic torques may be used to actuate the links, one at a time, by designing a suitable θ₁ trajectory for the actuated link 50. All other links must be locked prior to the actuation of the target link.

The advantage of such a system is the drastic reduction in the number of actuators required to reconfigure the structure. The presence of actuators at each rotary joint would have made the system extremely bulky and unsuitable for our application. Our proposed scheme uses a single actuator and thus results in a very compact structure which is scalable to multiple links.

We analyze the system in order to determine the input-output relationship between the actuated and underactuated joints. Lagrange's equations of motion for the 2-link robot arm can be written as:

$$H ( q ) \ddot{q} + f ( q , \dot{q} ) + g ( q ) = τ \\ where \text{:} \\ q = [ \begin{matrix}{θ}_{1} \\ {θ}_{2}\end{matrix} ] , τ = [ \begin{matrix}{τ}_{1} \\ 0\end{matrix} ] \qquad ( 1 )$$

The equation of motion of the unactuated link may be written as:

$${H}_{12} ( {θ}_{2} ) {\ddot{θ}}_{1} + {H}_{22} {\ddot{θ}}_{2} + {f}_{2} ( {θ}_{2} , {\dot{θ}}_{1} ) + {g}_{2} ( {θ}_{2} ) = 0 \\ ⇒ {\ddot{θ}}_{2} = - \frac{{H}_{12} ( {θ}_{2} )}{{H}_{22}} {\ddot{θ}}_{1} - \frac{{F}_{2} ( {θ}_{2} )}{{H}_{22}} {\dot{θ}}_{1}^{2} - \frac{{G}_{2} ( {θ}_{2} )}{{H}_{22}} g sin {θ}_{1} \\ Here \text{:} \\ \begin{matrix}{H}_{12} = {M}_{2} ( {z}_{c 2} + {d}_{2} ) [ {y}_{c 2} cos {θ}_{2} + ( {x}_{c 2} + {a}_{2} ) sin {θ}_{2} ] + \\ {I}_{yz 2} cos {θ}_{2} + {I}_{xz 2} sin {θ}_{2}\end{matrix} \\ {H}_{22} = {I}_{zz 2} + {M}_{2} ( {( {x}_{c 2} + {a}_{2} )}^{2} + {y}_{c 2}^{2} ) \\ \begin{matrix}{F}_{2} = [ {I}_{xy 2} cos 2 {θ}_{2} + .5 ( {I}_{yy 2} - {I}_{xx 2} ) sin 2 {θ}_{2} + {M}_{2} ( {a}_{1} + \\ ( {x}_{c 2} + {a}_{2} ) cos {θ}_{2} - {y}_{c 2} sin {θ}_{2} ) ( ( {x}_{c 2} + {a}_{2} ) \\ sin {θ}_{2} + {y}_{c 2} cos {θ}_{2} ) ]\end{matrix} \\ {G}_{2} = - {M}_{2} [ {y}_{c 2} cos {θ}_{2} + ( {x}_{c 2} + {a}_{2} ) sin {θ}_{2} ] \qquad ( 2 )$$

Mᵢ, Iₓₓᵢ etc. denote the mass and inertias of link i. x_{ci}, aᵢ etc. denote the distance of the center of mass and the Denavit-Hartenberg parameters of the i^{th} link with respect to the (i-1)^{th} coordinate system.

It may be shown that (2) is a 2^{nd} order non-holonomic constraint and thus cannot be integrated to express θ₂ as a function of θ₁. It is sufficient to determine desired θ₁ trajectories θ_{1d}(t)) in order to achieve point to point control of θ₂. Once θ_{1d}(t) is obtained, we can set the input joint torque τ₁ to be:

τ₁=((\ddot{θ}_{1d}−2λ θ̅₁−λ² θ̅₁)+F₁+G₁)/N₁₁ (3)

Here N=H⁻¹ and θ̅₁=θ_{1d}−θ₁. By choosing the gain A appropriately, we can ensure that the resulting error dynamics is exponentially stable.

We first explore the qualitative behavior of the differential equation expressing the 2^{nd} order nonholonomic constraint in order to better understand the dominant dynamic effects. We refer to the terms involving θ₁ and its derivatives as the control input and terms involving θ₂ as the modulating coefficients. The modulating coefficients are solely dependent on the angular position of the unactuated link, whereas we can design the control input so as to get a desired motion of the unactuated link.

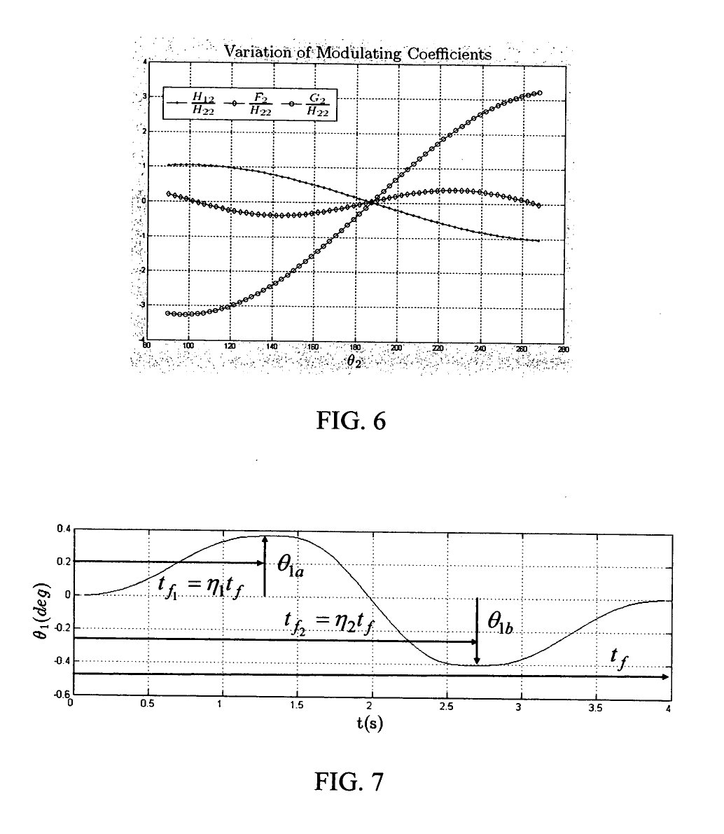

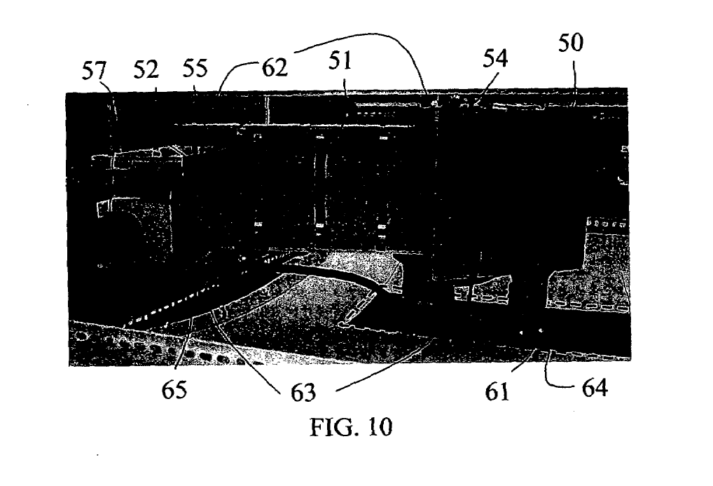

FIG. 6 shows the variation of the modulating coefficients with angular positions θ₂. We note that θ₂ ranges from 90° to 270° in our coordinate system. The parameter values are taken from our actual robotic system, which is shown in FIG. 10. Clearly, the dominant term is the modulating coefficient G₂ due to gravity, followed by the contribution of the inertial term H₁₂ and finally the contribution of the centrifugal term F₂. We also identify points in the configuration space of the unactuated coordinate where the modulating coefficients change sign. We will use these features in the design of control inputs so as to get desired outputs for the unactuated coordinate.

Control Algorithm

There are 3 regimes of motion of the unactuated coordinate θ₂ based on the sign of the dominant modulating coefficient G₂:

1. G₂(θ₂)>0 during motion

2. G₂ (θ₂) <0 during motion

3. G₂ (θ₂) changes sign during motion

From (2), we may conclude that the control input θ₁ must start from 0 and return to 0 at the end of the motion. Further, we may infer that the control input θ₁ undergoes at least one change of sign when the motion of the unactuated coordinate is in the 1^{st} or 2^{nd} regime. In the 3^{rd} regime, no change of sign is necessary. We construct the θ₁ trajectory by smoothly patching together 3 piecewise polynomial sigmoid segments, as shown in FIG. 7.

We parameterize the θ₁ trajectory as follows:

θ₁(t)=[10(t/t_{f}_{₁})³−15(t/t_{f}_{₁})⁴+6(t/t_{f}_{₁})⁵]θ₁ₐ0≦t≦t_{f}_{₁}

θ₁(t)=[10(t_{f}_{₂}−t/t_{f}_{₂}−t_{f}_{₁})³−15(t_{f}_{₂}−t/t_{f}_{₂}−t_{f}_{₂})⁴+6(t_{f}_{₂}−t/t_{f}_{₂}−t_{f}_{₁})^{5](θ}₁ₐ−θ₁ₕ)+θ₁ₕt_{f}_{₁}≦t≦t_{f}_{₂} (4)

θ₁(t)=[10(t_{f}−t/t_{f}−t_{f}_{₂})³−15(t_{f}−t/t_{f}−t_{f}_{₂})⁴+6(t_{f}−t/t_{f}−t_{f}_{₂})⁵]θ₁ₕt_{f}_{₂}≦t≦t_{f}

We need to determine the parameters θ₁ₐ, θ_{1b}, η₁, η₂ and t_{f} of the θ₁ trajectory for point to point motion of θ₂ between θ₂₀ and θ_{2f}. We do this by substituting the parameterized control input in (2) and solving it as a 2 point boundary value problem (bvp). The system (2) becomes a 2^{nd} order bvp with 4 boundary conditions and 5 unknown parameters to be determined. The boundary conditions are:

θ₂(0)=θ₂₀, \dot{θ}₂(0)=\dot{θ}₂₀, θ₂(t_{f})=θ_{2f}\dot{θ}₂(t_{f})=\dot{θ}_{2f}

This system is clearly indeterminate. We thus fix 3 of the unknown parameters, viz. η₁, η₂ and t_{f}, and solve the 2^{nd} order bvp for θ₁ₐ and θ_{1b}. This is motivated by the fact that θ₁ₐ and θ_{1b} are linearly involved parameters if we ignore the weak term associated with \dot{θ}₁². The parameter values η₁ and η₂ are fixed such that η₁=η₂−η₁=1−η₂=⅓. We note that if θ₁(t) (with parameters θ₁ₐ and θ₁ₕ) is an input trajectory for motion of the unactuated coordinate from θ₂₀ to θ_{2f} in time t_{f}, \dot{θ}₁(t)=θ₁(t_{f}−t) is the input trajectory for motion from θ_{2f} to θ₂₀. Since η₁=η₂−η₁=1−η₂=⅓ the parameters for the sigmoid trajectory for retraction are \dot{θ}₁ₐ=θ_{1b} hand \dot{θ}_{1b}=θ₁ₐ. Thus, we do not need to recompute the parameters of the sigmoid trajectory for retraction of the free link 51. The parameter t_{f} may be set to get a desired average speed of motion required for point to point movements.

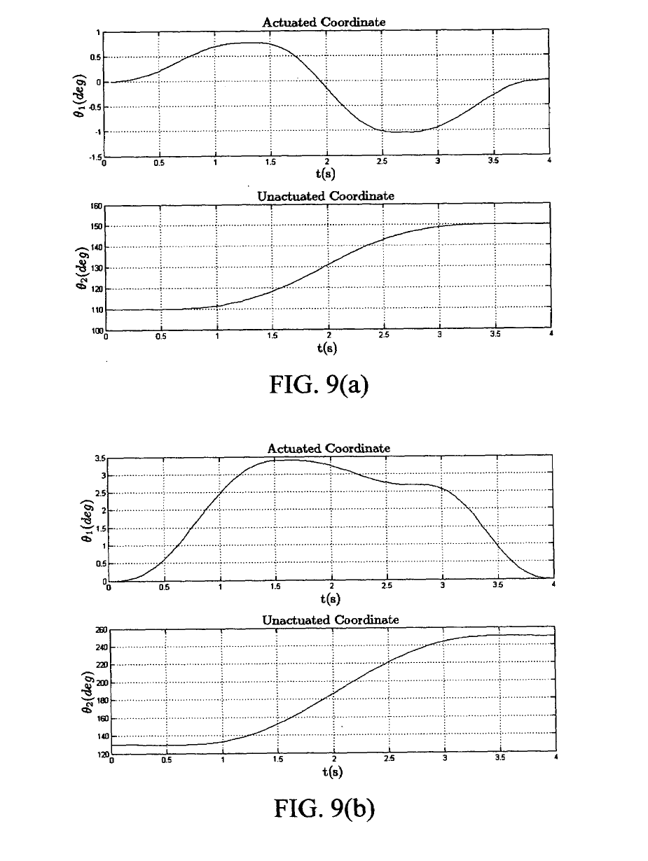

In the simulation results, 3 of the parameters were fixed at η₁=⅓, η₂=⅔ and t_{f}=4. It should be noted that other solutions may be obtained by changing η₁ and η₂, but we need to recompute the parameters θ₁ₐ and θ₁ₕ for retraction. The results are shown in FIG. 9(a) for θ₂(0)=110°, \dot{θ}₂(0)=0, θ₂(t_{f})=150°, \dot{θ}₂(t_{f})=0. The 2 unknown parameters for the θ₁ trajectory are θ₁ₐ=76° and θ₂ₐ=1.04°. FIG. 9(b) shows the results for θ₂(0)=130°, \dot{θ}₂(0)=0, θ₂(t_{f})=250°, θ₂(t_{f})=0. The 2 unknown parameters for the θ₁ trajectory are: θ₁ₐ=3.13° and θ₂ₐ=2.63°. As desired, the motion of the base link is restricted to very small amplitudes in both cases.

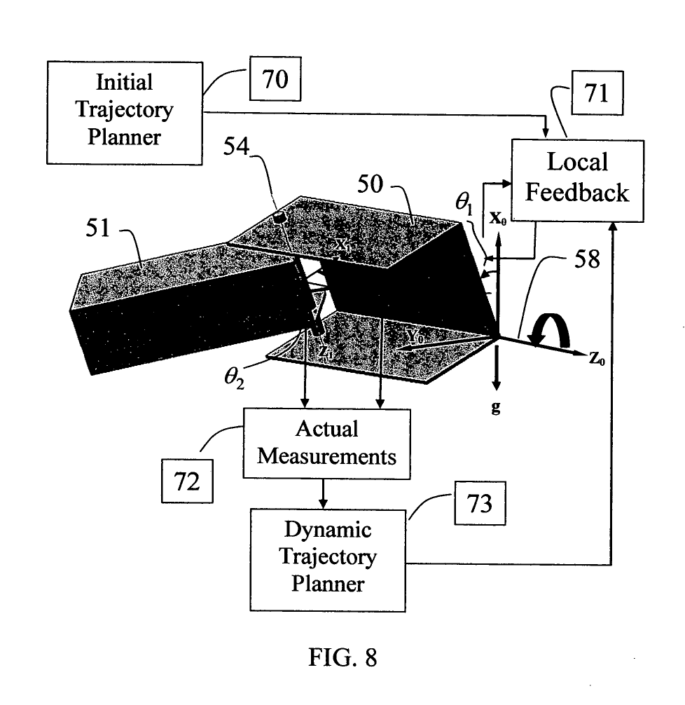

FIG. 8 shows the overall control scheme for a 2-link arm in the presence of disturbances. There may be disturbances acting on the unactuated joint 54 during the motion of the unactuated link 51 causing it to deviate from its predicted trajectory. The initial motion plan for the actuated joint 58 is generated by the initial trajectory generator 70. The actuated joint 58 is controlled through a local feedback loop 71. The motion plan for the actuated joint 58 is updated by the dynamic trajectory planner 73 based on actual measurements of position and velocity 72.

### Embodiments

FIG. 5 shows the preferred embodiment of the robot arm with 3 C-links 50-52. A T-link 61 is rigidly connected to link 50. An AC servo motor (with optical encoder) 59 coupled to harmonic drive gearing 60 is used as a backlash free actuation mechanism. This mechanism is used to rotate the T-link 61 and link 50 about axis 58. This embodiment has optical encoders 62 at the free joints for measuring angular positions of the unactuated links 51-52. This embodiment also uses pneumatic brakes 63 as locking mechanisms at the free joints.

FIG. 10 shows an image of the preferred embodiment of the robot arm with 3 C-links 50-52. The arm is inside a mock-up of an airplane wing box 65. The arm enters the wing box 65 through an access porthole 64. There is also a payload 57 attached to the terminal link 52.

1. A multiple degree of freedom nested link serial manipulator comprising:
a T-link;
a plurality of successively smaller nested C-links with the biggest C-link rigidly connected to said T-link;
an actuated rotational joint with joint axis orthogonal to the direction of gravity for actuating said T-link;
a sensor at said actuated rotational joint for measuring the angular position of said T-link;
a plurality of unactuated joints with parallel joint axes orthogonal to said actuated joint axis for connecting said adjacent C-links;
a plurality of sensors at said unactuated joints for measuring relative positions of said adjacent C links;
a plurality of locking mechanisms at said unactuated joints.

2. The manipulator of claim 1 wherein said locking mechanism is a pneumatic brake.

3. The manipulator of claim 1 wherein said locking mechanism is an electromagnetic brake.

4. The manipulator of claim 1 wherein said sensor is an optical encoder.

5. A method of controlling said manipulator comprising the steps of:
designating one of said unactuated joints for motion from an initial position to a desired final position with zero final velocity;
generating a sigmoidal motion plan for said actuated joint whereby the effect of gravity on the said unactuated joints is modulated such that said unactuated joint moves from said initial position to said desired final position with said zero final velocity;
unlocking said locking mechanism at said unactuated joint;
starting the execution of said motion plan on said actuated joint under local feedback;
measuring the position and velocity of said unactuated joint during said execution of motion on said unactuated joint;
updating said motion plan real-time based on said measurements;
controlling said actuated joint under said local feedback based on said updated motion plan;
locking said locking mechanism once the unactuated joint has reached said desired final position with said desired zero final velocity;
